(19) United States
(12) Patent Application Publication
(10) Pub. No.: US 2007/0042500 A1
(43) Pub. Date: Feb. 22, 2007

(54) Direct observation of molecular modifications in biological test systems by measuring flourescence lifetime

(75) Inventors: Frans-Josef Meyer-Almes, Otzberg-Lengfeld (DE); Gabriele Wirtz, Wuppertal (DE)

Correspondence Address: JEFFREY M. GREENMAN, BAYER PHARMACEUTICALS CORPORATION, 400 MORGAN LANE, WEST HAVEN, CT, 06516, US

(73) Assignee: Bayer Healthcare AG, Leverkusen (DE)

(21) Appl. No.: 10/575,026

(22) PCT Filed: Oct. 5, 2004
(86) PCT No.: PCT/EP04/11100

§ 371 Date: Oct. 2, 2006

(30) Foreign Application Priority Data
Oct. 18, 2003 (DE) 103 48 949.5
May 5, 2004 (DE) 10 2004 022 107.3

(51) Int. Cl. G01N 21/76

(52) U.S. Cl. 436/172

(57) ABSTRACT

The invention relates to a method for directly detecting the modification of a molecule containing a fluorescent dye by measuring the fluorescence lifetime.

The invention relates to a method for directly detecting the modification of a molecule containing a fluorescent dye by measuring the fluorescence lifetime.

Introduction to Fluorescence Spectrometry

All processes accompanying an emission of radiation during the transition of an excited molecule to its energetic ground state are referred to as luminescence and are usually divided into fluorescence and phosphorescence. In addition, the excitation energy may be released by various nonradiating processes.

Fluorescence occurs during the transition from the lowest vibrational level of the excited singlet state S₁ to a vibrational level of the singlet ground state S₀. The rate of transition, k_{f}, is in the range from 10⁷ to 10¹² s⁻¹. Fluorescence excitation occurs at a lower wavelength than fluorescence emission, since energy is lost between absorption and release of radiation energy due to radiationless processes.

Fluorescence lifetime (FLT) is a measure for the amount of time a molecule spends on average in the excited state before fluorescence emission takes place. The radiation lifetime τ_{f} corresponds to the inverse rate of fluorescence transition, k_{f}. In contrast to this radiation lifetime of excited molecules, said radiationless processes must be taken into account for contemplating the actual—measurable—FLT τ of the excited molecules:

$$τ = \frac{1}{{k}_{f} + {k}_{ic} + {k}_{isc} + {k}_{Q}} ,$$

where k_{ic}=rate of transitions between vibrational states, k_{isc}=rate of transitions to triplet states, k_{Q}=quenching rate. It is apparent from this inter alia that a fluorescence quencher decreases the FLT. A similar action is displayed by “acceptor dyes” which absorb the excitation energy of the donor dye in a radiationless manner by way of a resonance phenomenon and release the absorbed energy either in a radiationless manner or as fluorescence. This likewise decreases the FLT of the donor dye.

Methods of Measuring Fluorescence Lifetime (FLT)

Two fundamentally different methods are applied to measuring FLT: measurements in the time domain (TD) and measurements in the frequency domain (FD).

In TD-FLT, the sample is excited by a short pulse of light and the fluorescence decay curve is measured. It is possible in principle to record on the one hand the complete decay curve for each flash. However, this requires a transient recorder with high time resolution and a bandwidth in the gigahertz range. In most cases, however, the “time correlated single photon counting” (TCSPC) method is applied. TCSPC is a digital technique which counts photons temporally correlating with the excitation pulse. In this method, the experiment starts with an excitation pulse exciting the sample and starting a very fast clock. As soon as the first emitted fluorescence photon reaches the detector, the clock stops and the time is stored. This process is repeated many times. Since the process of fluorescence emission is a random process, different times will be obtained. Plotting the frequency of these measuring times as a function of the measuring time results in a fluorescence decay curve whose time constant is the FLT (see FIG. 1).

An alternative to FLT measurements in the time domain are measurements in the frequency domain which are also called phase modulated. The sample is excited by a continuous laser whose light intensity is modulated using a sinusoidal curve. Usually frequencies in the order of magnitude of the fluorescence transition rates are employed. When a fluorescent dye is excited in this way, its emission is forced to follow said modulation. Depending on the FLT, emission is delayed relative to excitation. This delay is measured as phase shift from which the FLT can be calculated. Moreover, the maximum difference between the maximum and minimum of the modulated emission signal decreases with increasing FLT so that the FLT may also be calculated from this.

Fluorescent Measurement Methods for Detection of Biological Test Systems

The following methods inter alia have proved suitable for detection of biochemical test systems under the aspect of high throughput and high stability:

Measuring the fluorescence intensity may be used, for example, for measuring the increase in fluorescence of a protease reaction with a fluorogenic peptide substrate from which fluorescent aminocoumarine (AMC) is removed by cleavage. Normally large signals are measured but autofluorescence of screening substances might interfere. Moreover, the fluorescence intensity signal is susceptible to the “inner filter effect”, if the solution contains an absorbing substance. Dynamic fluorescence quenching due to molecular collision and also light scattering in cloudy solutions may interfere as well as bleaching of the fluorescent dye or volume/meniscus effects. The fluorescence signal moreover depends on the concentration of the fluorescent dye and on the temperature. All of these sources of interference create problems regarding the stability of such assays and their use as screening method. On the other hand, assays of this kind can be performed very easily with very short measuring times and have therefore developed into a standard in HTS.

If a small fluorescent molecule is bound, for example, to a substantially larger molecule, (e.g. a protein), it is possible to measure the slow-down in rotation diffusion of the large molecular complex produced by measuring stationary fluorescence polarization. This method too has meanwhile become a standard for binding reactions in HTS. Interfering influences due to the inner filter effect, light scattering, concentration and temperature are not noticeable. However, fluorescence polarization is also influenced by genuine collision quenching, autofluorescence, volume and meniscus of the solution.

Another method for binding events makes use of fluorescence resonance energy transfer (FRET) between a donor and an acceptor dye, where the emission spectrum of the donor dye overlaps with the excitation spectrum of the acceptor dye. One partner in the binding reaction in question must carry the donor dye and the other partner must carry the acceptor dye. FRET only occurs in the event of binding, due to spatial proximity. Inner filter effect, quenchers and autofluorescent substances interfere with the FRET measurement. In contrast, light scattering, photobleaching, volume and meniscus effects as well as concentration and temperature do not interfere. Therefore, in comparison with fluorescence intensity, both fluorescence polarization and FRET are relatively robust methods for measuring the interaction of molecules.

Fluorescence lifetime (FLT) is considerably more robust compared to the fluorescence methods mentioned. Only in a few cases, is there interference from strongly autofluorescent substances having a comparable FLT. But FLT is influenced neither by the inner filter effect nor by collision quenchers, photobleaching, volume effects or concentration. These properties predestine this robust method to the use in screening. On the other hand, no screening assays have been established for FLT to date, due thus far mainly to low throughput and high costs for instrumentation. Modern developments of powerful and stable lasers and also of detection systems have recently enabled FLT measurements to be introduced to microtiter plates and thus the screening of substances. Thus, the company Tecan has marketed for the first time a commercial apparatus for reading out microtiter plates, the Ultra Evolution, in late 2002.

Known FLT Applications:

FLT measurement was applied to a large variety of biological problems. Use was made here either of fluorescent probe molecules whose fluorescence properties and in particular fluorescence lifetimes are modified when said molecules bind to cations such as, for example, Ca²⁺ (Schoutteten L., Denjean P., Joliff-Botrel G., Bernard C., Pansu D., Pansu R. B., Photochem. Photobiol. 70, 701-709 (1999)), Mg²⁺ (Szmacinski H., Lakowicz J. R., J. Fluoresc. 6, 83-95 (1996)), H⁺ (Lin H. J., Szamacinski, Anal. Biochem. 269, 162-167 (1999)), Na⁺ (Lakowicz J. R., Szamacinski H., Nowaczyk K., Lederer W. J., Kirby M. S., Johnson M. L., Cell Calcium 15, 7-27 (1994)), K⁺ (Szmacinski H., Lakowicz J. R. in “Topics in Fluorescence Spectroscopy” Vol. IV, (Lakowicz, J. R., Ed.), 295-334 (1994)) or anions such as, for example, Cl⁻ (A. S. Verkman, Am. J. Physiol 253, C375-C388 (1990)). The change in fluorescence lifetime is also achieved by a binding reaction to a molecule which either produces a smaller FLT of the donor dye due to resonance energy transfer (quenching or FRET) or, in rare cases, causes a larger FLT. The activity of a receptor tyrosine kinase, for example, was measured with the aid of binding of a Cy3-labeled anti-phosphotyrosine antibody (F. S. Wouters, P. I. H. Bastiaens, Current Biology 9, 1127-1130, 1999).

No application of a biological test system which employs the change in FLT for measuring the modification of a molecule without involvement of a binding reaction has been described previously. On the other hand, an assay in which the modification of a molecule for example of a substrate by an enzyme, is measured directly would be of great advantage, since substrate conversion of a substrate could be measured directly without requirement of an enzyme cascade or a binding reaction which makes visible the primary substrate conversion indirectly. Substance screening has the advantage of the substances tested being no longer able to interfere with the detection reactions. This would prevent fake hits or substances which cannot be evaluated due to said interferences.

Screening Assay Formats for Kinases/Phosphatases

Protein (de)phosphorylation is a general regulatory mechanism which is used by the cells to selectively modify proteins which impart exterior regulatory signals to the nucleus. The proteins which carry out these biochemical modifications belong to the group of kinases or phosphatases. Phosphodiesterases hydrolyze the secondary messenger cAMP or cGMP and in this way likewise influence cellular signal transduction pathways. These enzymes are therefore target molecules of great interest to pharmaceutical and crop protection research.

Various formats for screening kinases have been established, all of which share the fact that the phosphorylation reaction is always measured indirectly (except for radioactive methods). These methods are therefore susceptible in principle to interference by substances interfering with the downstream enzyme cascade or binding reaction. Some methods are even limited to tyrosine kinases only.

Traditional methods of measuring the state of phosphorylation of cellular proteins are based on the incorporation of radioactive ³²P-orthophosphates. The ³²P-phosphorylated proteins are separated on a gel and subsequently visualized using a phosphoimager. Alternatively, phosphorylated tyrosine residues may be bound by binding radioactively labeled anti-phosphotyrosine antibodies and detected by immunoassays, for example immunoprecipitation or blotting. These methods are time-consuming, since radioactive isotopes need to be detected, and are also not suitable for high throughput screening (uHTS, ultra high throughput screening), owing to the safety aspects concerning the handling of radioactive substances. More recent methods replace the radioactive immunoassays with ELISAs (enzyme-linked immuno-sorbent assay). These methods use purified substrate proteins or synthetic peptide substrates 11immobilized on a substrate surface. After treatment with a kinase, the extent of phosphorylation is quantified by anti-phosphotyrosine antibodies coupled to an enhancer enzyme, for example peroxidases, binding to the phosphorylated immobilized substrates.

Epps. et al. (U.S. Pat. No. 6,203,994) describe a fluorescence-based HTS assay for protein kinases and phosphatases, which employs fluorescently-labeled phosphorylated reporter molecules and antibodies which specifically bind said phosphorylated reporter molecules. Binding is measured by means of fluorescence polarization, fluorescence quenching or fluorescence correlations spectroscopy (FCS). This method has the intrinsic disadvantage of only good generic antibodies (e.g. clone PT66, PY20, Sigma) for phosphotyrosine substrates being available. Only a few examples of suitable anti-phosphoserine or anti-threonine antibodies have been reported (e.g. Bader B. et al., Journal of Biomolecular Screening, 6, 255 (2001), Panvera-Kit No. P2886). However, these antibodies have the property of recognizing not only phosphoserine but also the adjacent amino acids as epitope. It is known, however, that kinase function is very substrate-specific and that the substrate sequences can differ greatly. Therefore anti-phosphoserine antibodies cannot be used as generic reagents.

Perkin Elmer (Wallac) supplies an assay for tyrosine kinases which is based on time-resolved fluorescence and an energy transfer from europium chelates to allophycocyanine (see also EP929810). Here too, due to the use of antibodies, the method is restricted essentially to tyrosine kinases.

Recently, Molecular Devices has offered nanoparticles having charged metal cations on their surface as a generic binding reagent which is suitable for phosphorylation reactions both on tyrosine and on serine and threonine. However, the binding reaction is carried out at a strongly acidic pH of approx. 5 and at high ionic strength. Binding of the nanoparticles therefore requires the reaction to be greatly diluted in the target buffer, which, with total assay volumes of 10 μl in the 1536 format in uHTS, is a problem. Binding here is also measured by means of fluorescence polarization.

As a method of measurement, fluorescence polarization is relatively complicated and currently does not allow any parallel measurements of a microtiter plate (MTP). Measuring times for a 1536-MTP would therefore be very long and parallel measurement of enzyme kinetics would not be possible. Moreover, the method of fluorescence polarization is limited to very small fluorescent substrates.

Kinase activity may furthermore be measured by way of ATP consumption by means of firefly luciferase or by way of ADP formation by means of a downstream enzyme cascade. These assay formats are disadvantageous in that, owing to the indirect method of measurement, they not only generate greater data scattering but also have problems with substances inhibiting said cascade enzymes.

If phosphorylation/dephosphorylation were able to be measured directly by FLT detection, then measurement would be more direct and consequently would contain fewer systematic or random errors. Moreover, the limitation of some assay formats to tyrosine kinases or phosphatases would be removed, since a specific antibody would no longer be required.

Current Assay Problems:

In very many cases it is possible to use fluorogenic substrates containing C-terminal dyes such as, for example, aminocoumarine for proteases where C-terminal amino acids are removed. Endoproteases which cut in the middle of peptide sequences can usually be measured well in FRET assays, with the donor (e.g. EDANS) and acceptor dyes (e.g. Dabcyl) being located on the ends of the substrate. Substrate cleavage increases the fluorescence intensity because the acceptor dye can no longer quench the donor dye. There are, however, also proteases for which no fluorogenic substrates can be constructed. In such cases, the enzyme reaction must be measured either by means of complicated chemical analysis (e.g. HPLC/MS, GC/MS) or indirectly by chemical reaction or enzyme cascades. As a result, any disadvantages with respect to the stability of the assay and to unspecific reactions of screening substances with the detection reaction must be accepted. The complicated analysis is not suitable for high throughput screening. Enzymes whose reactions—in the throughput required—cannot be measured directly include those which carry out, for example, the following modifications on substrates: phosphorylation/dephosphorylation, sulfation/desulfation, methylation/demethylation, oxidations/reductions, acetylation/deacetylation, amidation/deamidation, cyclization/decyclization, conformational changes, removal of amino acids/peptides/coupling of amino acids/peptides, ring expansion/ring contraction, rearrangements, substitutions, eliminations, addition reactions, etc.

Description of the Invention:

Fluorescence lifetime (FLT) changes in principle with changes in the chemical environment. However, such changes in FLT cannot be generally predicted yet, in particular if the molecular modifications are small. Therefore any FLT assays previously published always included a binding reaction, either with a sensor molecule or with a quenched partner molecule.

Surprisingly, we found in our experiments that peptides which differ only by a phosphorylation already have distinctly different FLTs. More detailed experiments have shown that this statement can be extended to a further peptide. In order to obtain for this acceptable FLT differences between the phosphorylated and the non-phosphorylated peptide, diverse conditions had to be tested beforehand. However, the experiment also revealed clearly that FLT differences can be optimized by changing parameters. Based on these experiments, it should be possible to extend FLT measurements to all kinase and phosphatase reactions. In addition, other reactions which cannot be measured by previous methods with regard to HTS suitability or can be measured only very indirectly should also be accessible. In general, the following should apply:

If, for example, the state of phosphorylation of a reactant changes with conversion of the latter into its product, then a dye suitably coupled thereto should indicate this molecular modification by a change in FLT. Such a method has the potential of being applicable generically to tyrosine as well as to serine/threonine kinases and to phosphatases. The principle should also be applicable to other modification reactions, such as, for example, sulfation/desulfation, methylation/demethylation, oxidations/reductions, acetylation/deacetylation, amidation/deamidation, cyclization/decyclization, conformational changes, removal of amino acids/peptides/coupling of amino acids/peptides, ring expansion/ring contraction, rearrangements, substitutions, eliminations, addition reactions, etc. It is actually possible to carry out FLT measurements very rapidly (sometimes 50 ms or less per well) so that the method is suitable for high throughput screening. Particularly advantageous for HTS applications is great robustness to interfering influences such as, for example, inner filter effect, autofluorescence, light scattering, photobleaching, volume/meniscus effects, concentration of the fluorescent substrate.

It follows from the application that only 2 components, substrate and enzyme, must be mixed in order to start and measure the reaction. Conventional assay methods usually require the addition of further reagents such as, for example, cascade enzymes, in order to be able to record the reaction by measurement. Each pipetting step causes a pipetting error and thus an additional error for the measured result, which is also called error propagation. These propagated errors result in an increased variance of the measured results.

With the pipetting of very small volumes, as in substance screening, the errors of each individual step can no longer be disregarded. It is therefore necessary for any test systems in which small volumes need to be pipetted, and in particular for substance screening, to reduce the number of sources of error and thus also the number of pipetting steps.

It follows from this, that the present invention makes possible simple, more robust and more accurate measurement results than conventional assay methods. These advantages become particularly noticeable in substance screening.

The homogeneous assay method according to the invention or method according to the invention of directly and quantitatively measuring molecule modifications is characterized in that the molecule carries a fluorescent dye and that the fluorescence lifetime of said molecule differs from the fluorescence lifetime of the modified molecule. The fluorescence lifetime of the modified molecule may be greater than that of the unmodified molecule. However, the invention also comprises an assay method according to the invention in which the fluorescence lifetime of the modified molecule is less than that of the unmodified molecule.

The molecule may be, for example, an organic molecule, in particular a peptide or peptidomimetic, or an inorganic molecule. The fluorescent dye may be, for example, a coumarine, a fluoresceine, a rhodamine, an oxazine or a cyanine dye. The fluorescent dye used may be covalently or noncovalently coupled to the molecule. A spacer molecule may be located between the fluorescent dye and the molecule. The invention likewise relates to the use of the assay method according to the invention or method according to the invention for quantifying biochemical assays. The assay method according to the invention or method according to the invention may be used for quantifying biochemical assays in which enzymes may carry out, for example, the following modification reactions: phosphorylation/dephosphorylation, sulfation/desulfation, methylation/demethylation, oxidations/reductions, acetylation/deacetylation, amidation/deamidation, cyclization/decyclization, conformational changes, removal of amino acids/peptides/coupling of amino acids/peptides, ring expansion/ring contraction, rearrangements, substitutions, eliminations, addition reactions etc. Moreover, the assay method according to the invention or method according to the invention may be employed in a useful manner for use in high throughput screening—in particular in high throughput screening for identifying pharmaceutical active compounds.

The invention furthermore relates to a reagent kit comprising fluorescent dye-molecule conjugates and other reagents required for carrying out the assay method according to the invention or method according to the invention.

### DESCRIPTION OF THE FIGURES

FIG. 1: Fluorescence decay time course (logarithmic scale) of 15 nM of a fluoresceine-peptide conjugate. Measured on Ultra FLT prototype (TECAN) by means of TCSPC.

FIG. 2: Differences in the fluorescence lifetime of a phosphorylated (1) and non-phosphorylated (2) peptide (1: F1-P1], 2: F1-1). Measurement time 1 s. The mean and standard deviation of 10 measurements is shown.

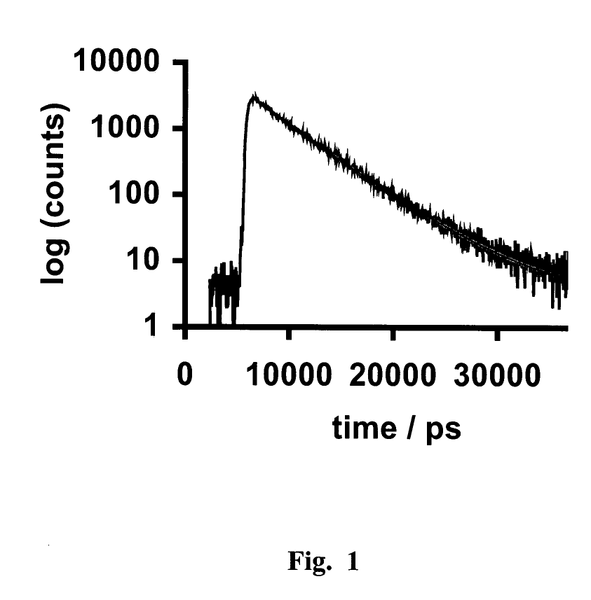

FIG. 3: The time course of fluorescence lifetime (FLT in ps) is plotted as a function of reaction time (time in s). During the reaction of PDE1b phosphodiesterase with fluoresceine-cAMP, 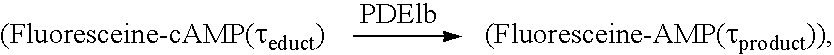
the fluorescence lifetime changes from approx. 3500 ps to approx. 3350 ps within 100 minutes. This change indicates directly the conversion of Fl-cAMP in Fl-AMP. The enzyme reaction is increasingly inhibited by increasing concentrations of BAY 383045 (green triangles: 20 μM, red squares: 10 μM, purple crosses: 5 μM, brown circles: 2.5 μM, pink squares: 1.25 μM, blue diamonds: 0.7 μM, green plus signs: 0.35 μM, dark blue minus signs: 0.17 μM, light blue minus signs: 0.08 μM).

FIG. 4: The differences in fluorescence lifetime between the phosphorylated and non-phosphorylated form of a fluoresceine-kemptide-peptides conjugate are plotted for different pH values and 200 mM NaCI (1: pH 13, 2: pH 9.5, 3: pH 8, 4: pH 7, 5: pH 200 mM NaCl, 7: pH 6.

FIG. 5: The fluorescence lifetimes of a potential reactant (FJ23, hashed) and its product (FJ24, black) of the conversion with the TAFI enzyme were measured under different conditions (1: water, 2: pH 6, 3: pH 7, 4: pH 8, 5: pH 9.5, 6: 00 mM NaCl, 7: 2 M NaCl). The fluorescence lifetimes are virtually independent of the conditions tested. However, the fluorescence lifetimes of FJ23 (552 ps) and FJ23 (2194 ps) differ very clearly.

### EXAMPLES:

1. Differences In the Fluorescence Lifetime of a Phosphorylated and a Non-Phosphorylated Peptide (FL-P1 vs. FL1)

Material:

Fl-P1: fluoresceine-C6-TEGQYpQPQP-COOH, Eurogentec, phosphorylated

Fl-1: fluoresceine-C6-TEGQYQPQP-COOH, Eurogentec, non-phosphorylated

Procedure:

It was intended to investigate whether there is a difference between the fluorescence lifetimes (FLTs) of the fluoresceine-peptide conjugates Fl-P1 and Fl-1. For this purpose, in each case 10 nM Fl-P1 and Fl-1 were dissolved in 50 mM HEPES pH 7.5. The fluorescence lifetimes (FLTs) were measured by means of an Ultra FLT prototype (Tecan). In each case, 10 measurements of 1 s each were averaged.

Result:

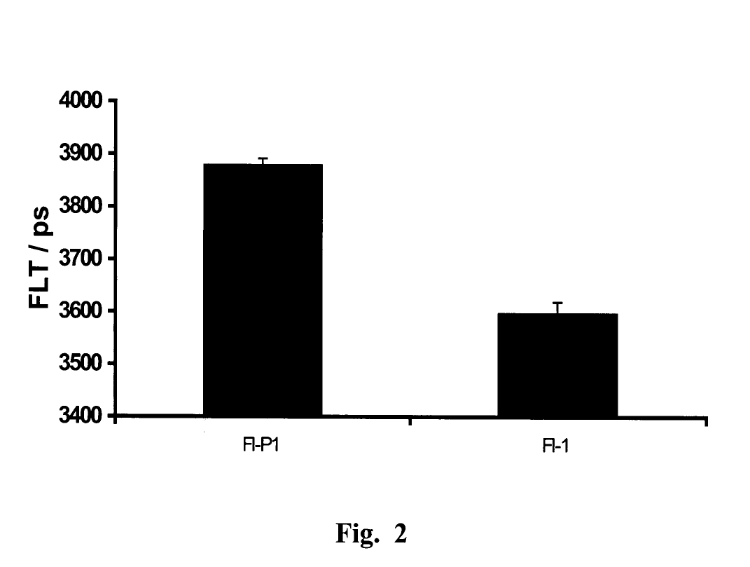

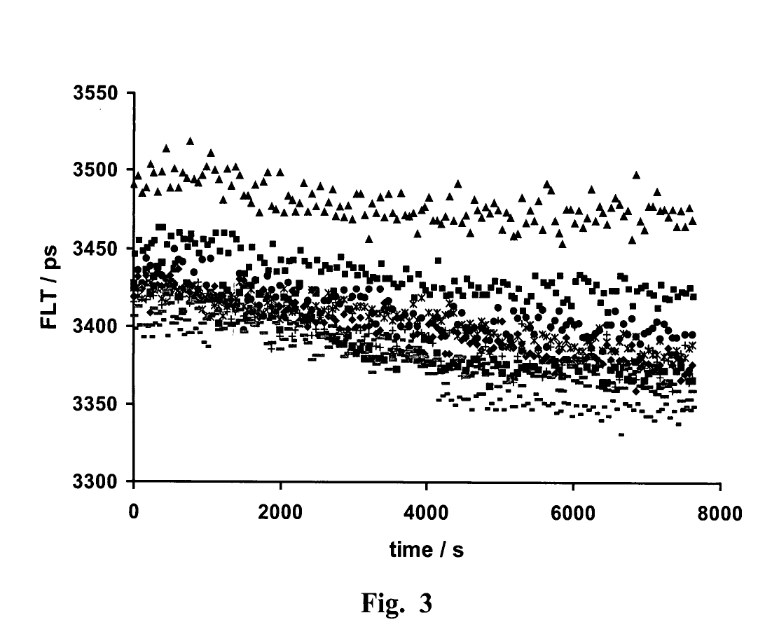

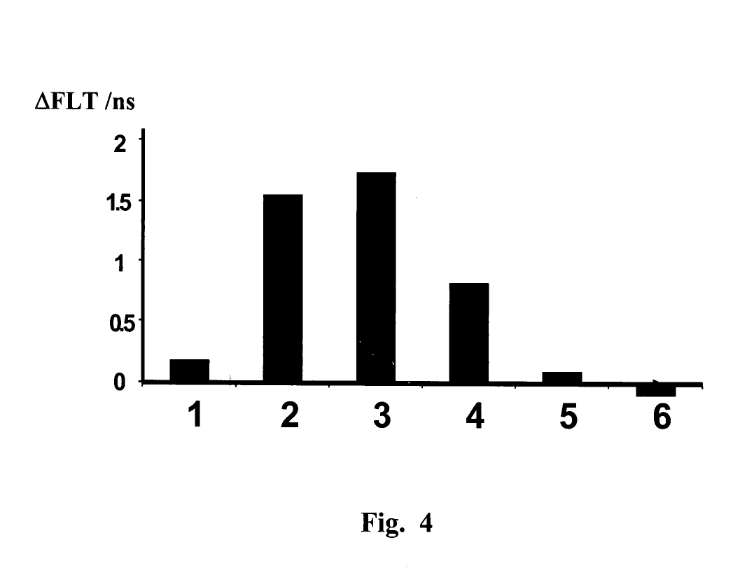

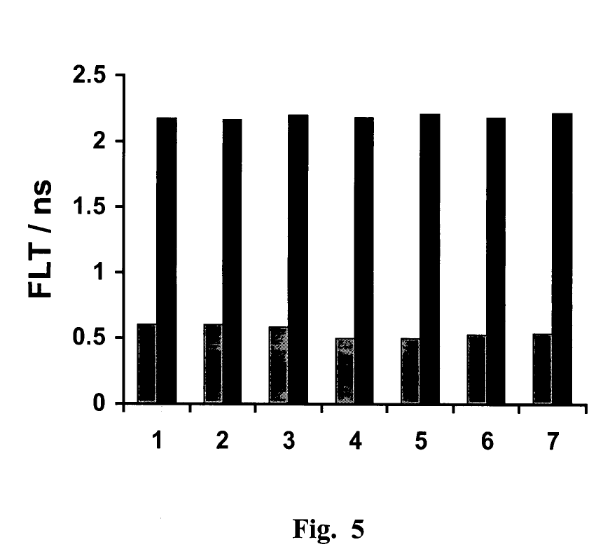

The fluorescence lifetime of Fl-P1 is 3880 ps and the FLT of Fl-1 is 3600 ps. Since the standard deviations for a measuring time of 1 s are very small (<25 ps), the two molecules can be distinguished very well (see FIG. 2). It is possible to calculate from the standard deviations and the average fluorescence lifetimes of Fl-P1 and Fl-1 a z′ factor of approx. 0.5 for the performance of a potential biological test with an FLT measurement window delimited by Fl-P1 and Fl-1, which would be sufficient for a screening campaign. The z′ factor was introduced by Zhang et al. 1999 for calculating the performance of HTS assays (Zhang J H, Chung T D Y, Oldenburg K R, J. Biomol. Screen 4, 67-73 (1999)). The activity of a kinase, such as for example p60^{src}, which would phosphorylate Fl-1 should be very well measurable by means of FLT measurements.

Many of the kinase assays currently in use are endpoint assays in which the kinetics cannot be monitored continuously. Rather, different reactions must be stopped at different times and the data obtained must then be assembled to give a kinetics curve.

Measurement of fluorescence lifetimes enables phosphorylation kinetics to be monitored directly and immediately without detection enzyme cascade. This facilitates in particular also the setting of the incubation time for a robot screening campaign.

2. Optimization of the Difference in FLT Between Fluoresceine-Labeled Phosphorylated and Non-Phosphorylated Kemptide Peptide

Material:

Fl-P-kemptide: fluoresceine-C6-LRRApSLGCONH₂, Eurogentec, phosphorylated

Fl-kemptide: fluoresceine-C6-LRRASLGCONH₂, Eurogentec, non-phosphorylated

0.1 M NaOH, 50 mM borate buffer pH 9.5, 50 mM HEPES buffer pH 8.0, 50 mM HEPES buffer pH 7.0, 50 mM MES buffer pH 6.0, 200 mM NaCl (low)

Procedure:

The quality of an FLT assay improves with increasing differences of the fluorescence lifetimes of reactant and product. An optimally large FLT difference will not be measured immediately in every case. On the other hand, it should be possible to increase the FLT difference initially obtained, for example by selecting and combining various parameters such as, for example, fluorescent dye, spacer molecule between dye and substrate molecule, or polarity, pH, ionic strength of the solvent or other additive. This example demonstrates how a significant increase in the FLT difference between a phosphorylated and a non-phosphorylated variant of a fluoresceine-kemptide-peptide conjugate (Fl-P-kemptide, Fl-kemptide) was achieved by increasing the pH. In each case 50 nM Fl-P-kemptide and Fl-kemptide were dissolved in the solutions described under Material, and their FLTs were measured by means of a modified Nanoscan instrument (IOM GmbH, Berlin, Germany) which transferred the signals to a transient recorder. 16 decay curves were averaged for each data point. The descending part of the logarithmic-scale curve was evaluated by means of linear regression and the negative slope was mathematically converted into FLT.

Result:

FIG. 4 indicates the differences in the FLTs of Fl-P-kemptide and Fl-kemptide under various conditions. The result here is that differentiation of the phosphorylated and non-phosphorylated form of kemptide by means of FLT improves when the pH increases from 6.0 to 9.5. The result obtained, together with the finding of the first example, suggests that it is possible, by selecting the correct fluorescent dyes, spacers and solvent properties or additives, to find for very many, if not nearly all, pairs of phosphorylated and non-phosphorylated peptide substrates for phosphatases or kinases conditions which result in a large difference between the fluorescence lifetimes between reactants and products which is sufficient for screening. Thus it is possible to construct, for the classes of enzymes mentioned, generic assays which can be developed very easily. Once the correct reaction conditions for the enzymes have been clarified, the reaction only requires the mixing of enzyme and substrate. The subsequent kinetics can be monitored immediately and directly. This enables incubation times on HTS robot apparatus to be readily set. Owing to the robust parameter of fluorescence lifetime, slight fluctuations in volume and substrate concentration affect the result of the measurement only slightly. In addition, an assay of this kind which has few pipetting steps is generally regarded as being markedly more robust than other standard assays with additional pipetting steps such as those sometimes required by detection enzyme cascades.

3. PDE Reaction

Material:

Fl-cAMP: 8-fluo-cAMP, BIOLOG Life Science Institute

PDE1b: phosphodiesterase 1b (Laboratory of Dr. A. Tersteegen, Bayer AG)

BAY 383045: Bayer AG

Procedure:

Like the phosphatases and kinases discussed above, phosphodiesterases are a very important class of targets, inter alia in the fields of indication of cardiovascular, metabolic disorders, central nervous system, cancer and respiratory diseases. It is therefore of great interest to have a generic assay format which can measure the conversion of cAMP or cGMP to the respective monophosphate. Usually detection enzyme cascades are used. This example demonstrates that it is possible to measure the phosphodiesterase reaction directly. In the experiment, first 1 μM Fl-cAMP and a 1:360 dilution of PDE1b were mixed in the presence of different concentrations of the inhibitor BAY 383045. The kinetics of the enzyme reaction was measured by means of an Ultra FLT prototype (Tecan) at room temperature.

Result:

The FLT of Fl-cAMP changes—without inhibitor—from approx. 3500 ps to approx. 3350 ps within 100 minutes in the course of the reaction to give Fl-AMP. Increasing concentrations of BAY 383045 increasingly inhibit said enzyme reaction (see FIG. 3). The distinct concentration dependence of the inhibition of the phosphodiesterase reaction revealed that the change in fluorescence lifetime of Fl-cAMP is clearly associated with the enzyme activity. This proves that it is possible to use this method in principle for the screening for substances which inhibit phosphodiesterases. However, the measurement principle should also be extendable to kinase and phosphatase assays and other enzyme assays if a measurable FLT change occurs during enzymic modification of the substrate. As for the phosphatase and kinase assays discussed above, a phosphodiesterase assay with direct FLT detection of substrate modification should be very robust owing to the interference-insensitive measured signal and few pipetting steps. The assay method described could be used to eliminate interference of substances with detection enzymes. The following applies in general for the described assay method on the basis of fluorescence lifetime measurements: the incubation times of phosphodiesterase, kinase and phosphatase assays as well as other enzyme assays can be set in an experiment very readily and accurately for a robot high throughput screening campaign, due to the direct and immediate measurement of enzyme kinetics.

4. Difference in Fluorescence Lifetime Between Reactant and Product of the TAFI Enzyme Reaction:

Material: FJ23: Evoblue30-Ttds(Spacer)-IFTR-COOH, Jerini Peptide Technologies
FJ24: Evoblue30-Ttds(Spacer)-IFTR-COOH, Jerini Peptide Technologies

Procedure:

The enzyme thrombin activated with fibrinolysis inhibitor (TAFI) is a carboxypeptidase which plays an important part in thromboses. TAFI cleaves the arginine of the peptide sequence IFTR. This reaction may be detected by either mass spectrometric or chromatographic methods. Both methods are not suitable for high throughput substance testing. Alternatively, more or less complex enzyme cascades or chemical reactions may be used which generate a measurable absorption, fluorescence or luminescence signal. No method has been described to date with which the TAFI reaction can be measured directly and which is suitable at the same time for higher throughput. Therefore, the fluorescence lifetimes of the conjugates FJ23 and FJ24 which both carry a fluorescent dye excitable at 630 nm (Evoblue30, Mobitec) and which differ only in the FJ24 conjugate lacking the C-terminal arginine were measured. FJ23 is a potential reactant of the TAFI reaction, while FJ24 would be the corresponding reaction product. The FJ23 and FJ24 conjugates were dissolved at a concentration of 60 nM in various buffers with pH values of 6, 7, 8 and 9.5, and in the presence of 200 mM and 2 M NaCl.

Result:

The fluorescence lifetime of FJ23 is (552±45) ps and that of FJ24 is (2194±18) ps, independent of the pH value and NaCl concentration (see FIG. 5). From this, an excellent z′ factor of 0.89 can be calculated which suggests that a very powerful assay can be expected. It was demonstrated, as already in the previous examples for kinases, phosphatases and phosphodiesterases, that it is possible to synthesize fluorescent conjugates of reactants and products, which - in the case of TAFI—have a very large difference in fluorescence lifetime. This large fluorescence lifetime difference involves the construction of an assay with great signal stability and very good differentiation between differently inhibiting substances. In addition, this example demonstrates a solution to the TAFI-specific problem that no methods suitable for high throughput have been described for TAFI to date which allow direct measurement of the enzyme reaction without secondary detection reactions.

1. A method of homogeneously, directly and quantitatively measuring molecule modifications, characterized in that the molecule carries a fluorescent dye and that the fluorescence lifetime of said molecule differs from the fluorescence lifetime of the modified molecule.

2. The method of claim 1, in which the molecule is an organic molecule, or is an inorganic molecule.

3. The method of claim 1, wherein the fluorescent dye is a coumarine, a fluoresceine, a rhodarnine, an oxazine, or a cyanine dye.

4. The method of claim 1, wherein the fluorescent dye is covalently or noncovalently coupled to the molecule and optionally a spacer molecule may be located between the fluorescent dye and the molecule.

5. The method of claim 1 for quantifying biochemical assays.

6. The method of claim 5, wherein enzymes can carry out the following modification reactions:
phosphorylation/dephosphorylation, sulfation/desulfation, methylation/demethylation, oxidations/reductions, acetylation/deacetylation, amidation/deamidation, cyclization/decyclization, conformational changes, removal of amino acids/peptides/coupling of amino acids/peptides, ring expansion/ring contraction, rearrangements, substitutions, eliminations, addition reactions.

7. The method of claim 1 for the use in high throughput screening.

8. A reagent kit comprising fluorescent dye-molecule conjugates and other reagents required for carrying out the assay method as claimed in claims 1 to 6.

9. The method of claim 2, wherein the organic molecule is a peptide or peptidomimetic.
